(19) United States
(12) Patent Application Publication
(10) Pub. No.: US 2023/0066938 A1
(43) Pub. Date: Mar. 2, 2023

(54) BATTERY CONNECTION MODULE AND BATTERY PACK

(71) Applicant: Molex, LLC, Lisle, IL (US)

(72) Inventors: Siow-Pheng GOH, Jurong Town (SG); Kian-Heng LIM, Central Horizon (SG)

(73) Assignee: Molex, LLC, Lisle, IL (US)

(21) Appl. No.: 17/889,572

(22) Filed: Aug. 17, 2022

Related U.S. Application Data
(60) Provisional application No. 63/238,127, filed on Aug. 28, 2021.

(51) Int. Cl. H01M 50/507; H01M 50/204; H01M 50/503

(52) U.S. Cl. CPC H01M 50/507; H01M 50/204; H01M 50/503

(57) ABSTRACT

A battery connection module and a battery pack are provided. The battery connection module includes a plurality of connecting busbars which are assembled on a tray. Each connecting busbar has a plurality of components, each component has a main body portion, a head portion which extends from a first end of the main body portion and a foot portion which extends from a second end of the main body portion, the head portion is connected to a positive electrode of a corresponding battery cell, the foot portion is connected to a negative electrode of a corresponding battery cell, the main body portions of the components of the connecting busbar are connected by a connecting portion. In each connecting busbar, at least one component connects two battery cells of adjacent columns, at least one component connects two battery cells of every other column, at least one component connects two battery cells in the same row, and at least one component connects two battery cells of adjacent rows.

### RELATED APPLICATIONS

The present disclosure claims a priority of U.S. provisional application US63/238,127 filed on Aug. 28, 2021, titled “busbar assembly for arrays of battery cells”, which is incorporated herein by reference in its entirety.

### TECHNICAL FIELD

The present disclosure relates to technical field of batteries, and particularly relates to a battery connection module and a battery pack.

### BACKGROUND ART

China Taiwanese patent TWI308406B (corresponding United States patent U.S. Pat. No. 7,811,701 B2) discloses a battery pack, each conductive plate of the battery pack includes a plurality of pairs of tab-shaped connecting points which extend from a left side and a right side of a conductive plate body and are symmetric, each conductive plate is used to connect two adjacent rows of batteries, the tab-shaped connecting points of each conductive plate are a construction which is symmetrically and regularly arranged, the batteries also is an arrangement which is symmetric and regular.

However, when it requires such a conductive plate to be used to connect more number of batteries than the number of batteries of such two adjacent rows, the construction of the conductive plate disclosed by the above patent cannot meet this requirement. For example, each column of batteries are three batteries, two columns of batteries are six batteries, based on the construction of the conductive plate disclosed by the above patent, the tab-shaped connecting points of the conductive plate are a construction which is symmetrically and regularly arranged, one conductive plate only can connect the six batteries of two adjacent columns, when it requires the one conductive plate to connect for example ten batteries at the same time under such the same arranged batteries, because the ten batteries to be connected at this time are not positioned at symmetric and regular positions, the construction disclosed by the above patent cannot meet this requirement.

### SUMMARY

One main object of the present disclosure is to provide a battery connection module in which a single connecting busbar can connect more numbers of battery cells and can connect a plurality of battery cells irregularly arranged, so as to overcome at least one deficiency of the above prior art.

Another main object the present disclosure is to provide a battery pack which has the battery connection module as above, so as to overcome at least one deficiency of the above prior art.

In order to realize the above objects, the present disclosure employs the following technical solutions.

According to one aspect of the present disclosure, a battery connection module is provided, is used to connect a battery cell array, the battery cell array comprises a plurality of columns and each column comprises battery cells and is the same in the number of battery cells, a battery cell of one column of adjacent columns is positioned between two corresponding battery cells of the other column of the adjacent columns, the plurality of columns repeat arrangement of the adjacent columns in a row direction and constitute a plurality of rows of the battery cells, a battery cell of one row of adjacent rows is positioned between two corresponding battery cells of other row of the adjacent rows, each battery cell has a positive electrode and a negative electrode which are positioned on the same end face, the battery connection module comprises: a tray; and a plurality of connecting busbars which are assembled on the tray. Each connecting busbar has a plurality of components, each component has a main body portion, a head portion which extends from a first end of the main body portion and a foot portion which extends from a second end of the main body portion, the head portion is connected to the positive electrode of a corresponding battery cell, the foot portion is connected to the negative electrode of a corresponding battery cell, the main body portions of the components of the connecting busbar are connected by a connecting portion. In each connecting busbar, at least one component connects two battery cells of adjacent columns, at least one component connects two battery cells of every other column, at least one component connects two battery cells in the same row, and at least one component connects two battery cells of adjacent rows.

According to another aspect of the present disclosure, a battery pack is provided and comprises a battery cell array and the battery connection module provided by the present disclosure and described in the above embodiment.

It can be seen from the above technical solutions, the battery connection module and the battery pack provided by the present disclosure has following advantage and beneficial effect.

Each battery cell of the array of the battery cells has the positive electrode and the negative electrode which are in the same end face, the battery cells of adjacent columns are staggered in the corresponding rows so that the battery cells forms a regular symmetric arrangement, in such an array of the battery cells , by the battery connection module promoted by the present disclosure, it can use one connecting busbar to realize connection with more number of the battery cells, can connect the battery cells which are not positioned in regular symmetric positions, at the same time can use a plurality of connecting busbars which each has a different irregular symmetric configuration to connect the battery cells.

### BRIEF DESCRIPTION OF DRAWINGS

Various objects, features and advantages of the present disclosure will become more apparent from consideration of the following detailed description of preferred embodiments of the present disclosure in conjunction with the accompanying drawings. The drawings are merely exemplary illustrations of the present disclosure and are not necessarily drawn to scale. Throughout the drawings, the same reference numerals always indicate the same or similar elements, in the drawings:

FIG. 1 is a perspective view that a battery connection module according to an exemplary embodiment is applied to a battery pack;

FIG. 2 is a top view of FIG. 1;

FIG. 3 is a bottom view of FIG. 1;

FIG. 4 is an enlarged view of a structure of a part of FIG. 1;

FIG. 5 is an enlarged view of an O region of FIG. 4;

FIG. 6 is an enlarged view of a structure of another part of FIG. 1;

FIG. 7 is another enlarged view of FIG. 1;

FIG. 8 is a perspective view of a partial structure of one battery cell array and connecting busbars;

FIG. 9 is an exploded schematic view of FIG. 8;

FIG. 10 is a perspective view of one connecting busbar A of the battery connection module of FIG. 9;

FIG. 11 is a top view of a partial structure of one battery cell array AR1 and connecting busbars without a tray shown;

FIG. 12 is a top view of another part of the one battery cell array AR1 and connecting busbars without a tray shown;

FIG. 13 is an enlarged view of a M region of FIG. 2;

FIG. 14 is an enlarged view of a N region of FIG. 2;

FIG. 15 is a side view of FIG. 1;

FIG. 16 is an enlarged view of a P region of FIG. 15;

FIG. 17 is an enlarged view of a Q region of FIG. 15;

FIG. 18 is an enlarged view of a R region of FIG. 2; and

FIG. 19 is a cross sectional view taken along a line S-S of FIG. 18.

### DETAILED DESCRIPTION OF THE PREFERRED EMBODIMENTS

Typical embodiments that embody features and advantages of the present disclosure will be described in detail in the following description. It should be understood that the present disclosure can have various changes in different embodiments, these changes does not depart from the scope of the present disclosure, and the description and drawings thereof are essentially used for description and are not used to limit the present disclosure.

In the following description of various exemplary embodiments of the present disclosure, reference is made to the accompanying drawings, the accompanying drawings forms a part of the present disclosure, and the accompanying drawings illustrates various exemplary structures, systems and steps which may realize a plurality of aspects of the present disclosure by way of example. It is to be understood that, other specific arrangements of elements, structures, exemplary devices, systems and steps may be utilized, and structural and function may be modified without departing from the scope of the present disclosure. Furthermore, although the present specification may use the terms “above”, “between”, “within” and the like to describe various exemplary features and elements of the present disclosure, these terms are used herein for convenience only, for example are based on orientation of the example shown in the figures. Nothing in the present specification should be construed as requiring a specific three-dimensional orientation of a structure to fall within the scope of this disclosure.

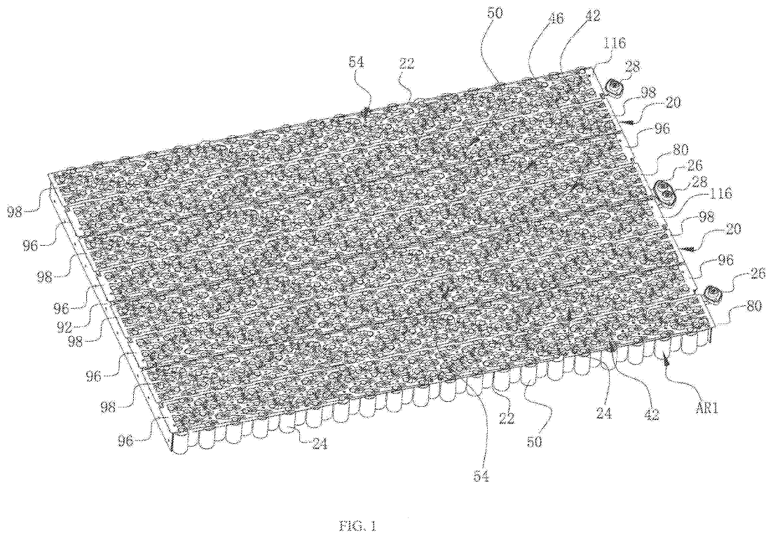

Referring to FIG. 1, FIG. 1 representatively illustrates a perspective view that the battery connection module 20 provided by the present disclosure is applied to a battery pack. Those skilled in the art can easily understand that, in order to apply the related designs of the present disclosure to other types of energy supply equipment, various modifications, additions, substitutions, deletions or other changes may be made to the following specific embodiments, these are still within the scope of the principles of the battery connection module 20 provided by the present disclosure.

As shown in FIG. 1, in an embodiment of the present disclosure, a battery pack provided by the present disclosure includes a battery cell array and a battery connection module provided by the present disclosure and described in detail in the above embodiment.

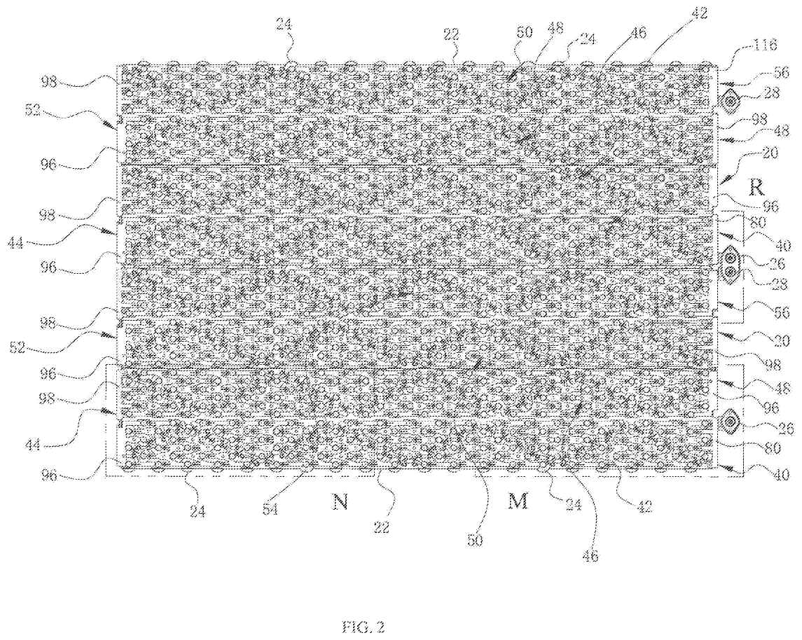

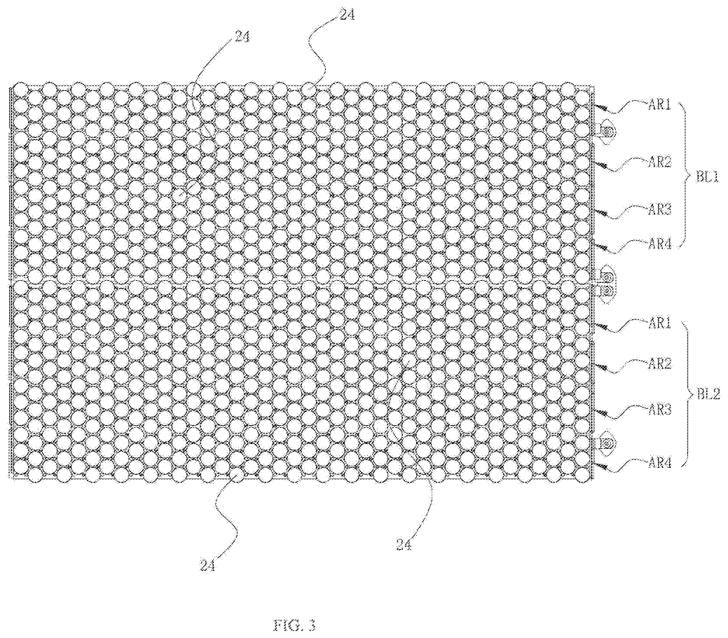

In an embodiment of the present disclosure, a battery connection module 20 provided by the present disclosure includes a tray 22 and a plurality of connecting busbars. The tray 22 may be a rigid insulating material, the plurality of the connecting busbar are attached to the tray 22. The battery connection module 20 is used to be mounted to a battery cell array. As shown in FIG. 1, FIG. 2 and FIG. 3, a battery pack includes two blocks BL1, BL2, each block has four battery cell arrays, for example, includes a first array AR1, a second array AR2, a third array AR3 and a fourth array AR4. An inputting interface 26 is electrically coupled to an inputting end of the connecting busbars which cover the first array AR1, an outputting interface 28 is electrically coupled to an outputting end of the connecting busbars which cover the fourth array AR4. A1 though four arrays AR1, AR2, AR3, AR4 are shown in figures, the present disclosure may be adapted to only include a single array or at least two arrays as the battery cell arrays.

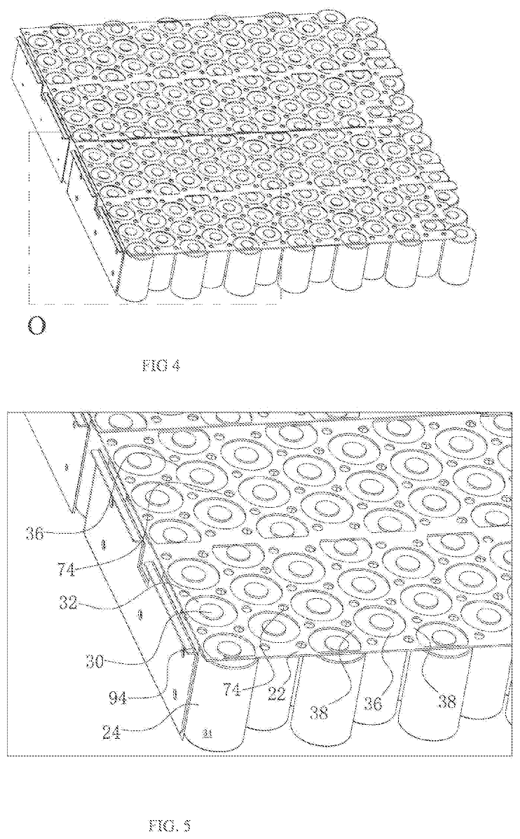

As shown in FIG. 4, FIG. 5 and FIG. 9, in an embodiment of the present disclosure, each battery cell 24 may have a positive electrode terminal 30, a negative electrode terminal 32 and a battery case 34, the positive electrode terminal 30 and the negative electrode terminal 32 is provided in the battery case 34, and the positive electrode terminal 30 is surrounded by the negative electrode terminal 32, the positive electrode terminal 30 and the negative electrode terminal 32 are exposed to a top of the battery case 34, and the positive electrode terminal 30 raises relative to the negative electrode terminal 32.

As shown in FIG. 4 and FIG. 5, in an embodiment of the present disclosure, the tray 22 is positioned to a top of the array AR1, AR2, AR3, AR4 of each block BL1, BL2, and the tray 22 has a plurality of openings 36, configuring direction of the plurality of openings 36 is the same as the array AR1, AR2, AR3, AR4 of the battery cells 24. When the tray 22 covers the array AR1, AR2, AR3, AR4 of each block B 1, B2, the opening 36 exposes the positive electrode terminal 30 and the negative electrode terminal 32 of each battery cell 24. In the embodiment as shown in FIG. 4, FIG. 5 and FIG. 9, there is a triangular region 38, which is substantial triangular, of the tray 22 among three corresponding battery cells 24. The tray 22 may be formed by a plastic.

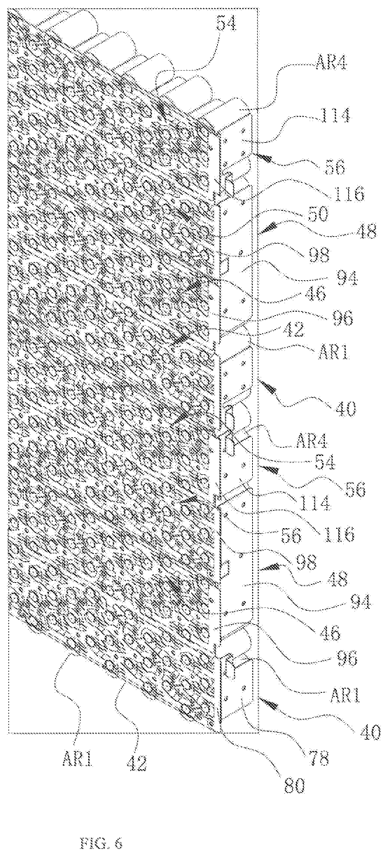

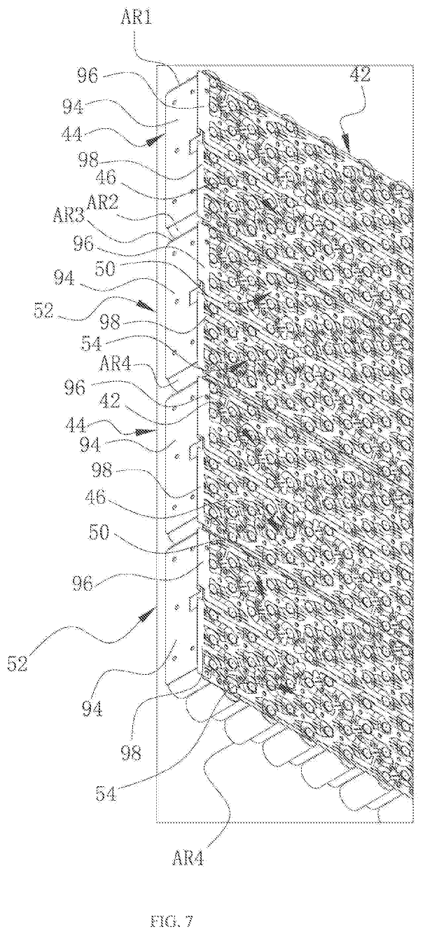

As shown in as shown in FIG. 2, FIG. 6 and FIG. 7, in an embodiment of the present disclosure, the battery connection module 20 includes an inputting busbar 40, a first group 42 of the connecting busbars (A to Nx) which cover the array AR1, a first bridging busbar 44 which connects the array AR1 to the array AR2, a second group 46 of the connecting busbars (A to Nx) which cove the array AR2, a second bridging busbar 48 which connects the array AR2 to the array AR3, a third group 50 of the connecting busbars (A to Nx) which cover the array AR3, a third bridging busbar 52 which connects the array AR3 to the array AR4, a fourth group 54 of the connecting busbars (A to Nx) which cover the array AR4, and an outputting busbar 56. The inputting busbar 40 is coupled to the inputting interface 26 and is coupled to a starting busbar A of the first group 42. The first group 42 covers the first array AR1, and the connecting busbars of the first group 42 are coupled with each other via the battery cells 24 of the first array AR1. The second group 46 covers the second array AR2 and the connecting busbars of the second group 46 are coupled with each other via the battery cells 24 of the second array AR2. The first bridging busbar 44 is coupled to an ending busbar Nx of the first group 42 and a starting busbar A of the second group 46. The third group 50 covers the third array AR3 and the connecting busbars of the third group 50 are coupled with the battery cells 24 of the third array AR3. The second bridging busbar 48 is coupled to an ending busbar Nx of the second group 46 and a starting busbar A of the third group 50. The fourth group 54 covers the fourth array AR4 and the connecting busbars of the fourth group 54 are coupled with the battery cells 24 of the fourth array AR4. The third bridging busbar 52 is coupled to an ending busbar Nx of the third group 50 and a starting busbar A of the fourth group 54. The outputting busbar 56 is coupled to the outputting interface 28 and is coupled to an ending busbar Nx of the fourth group 54.

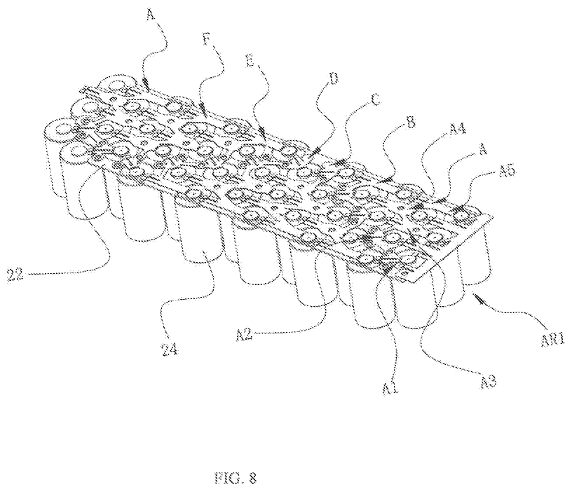

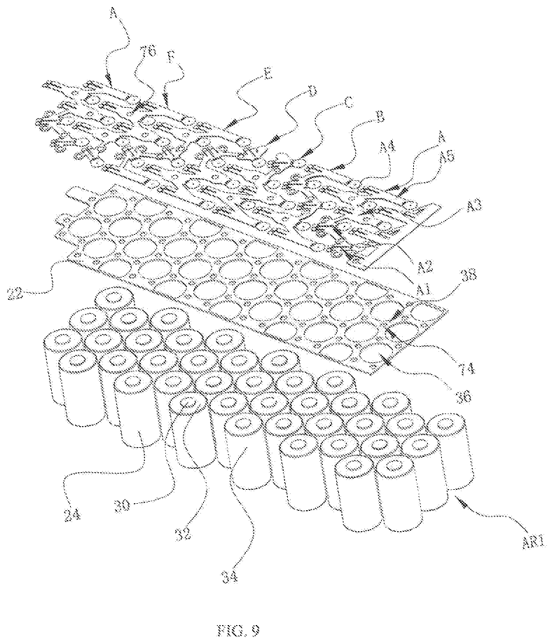

As shown in FIG. 8 to FIG. 12, in an embodiment of the present disclosure, each connecting busbar (A to Nx) has a plurality of components (A1-A5 to Nx-Nx5), adjacent components are coupled together via a connecting portion 58. Here, each connecting busbar (A to Nx) at least has two components and one connecting portion connecting the two components. Each connecting busbar (A to Nx) may have any number of the components and the connecting portion 58, specific design may be adjusted according to the battery array. The component (A1-A5 to Nx-Nx5) and the connecting portion 58 may be formed by a single piece of a material, for example, aluminum.

As shown in FIG. 8 to FIG. 12, in the present embodiment, the battery connection module 20 provided by the present disclosure is used to connect the array of the battery cells 24, the battery cells 24 are arrange side by side in columns (CL1 to CLX) and rows (R1 to R6), the battery cells 24 of adjacent columns are offset and staggered relative to each other, and the battery cells 24 of adjacent rows are offset and staggered relative to each other. In other words, the corresponding battery cell 24 of one column is positioned between the corresponding two battery cells 24 of the other column, and the corresponding battery cell 24 of one row is positioned between two corresponding battery cells 24 of the other row. Each battery cell 24 has a positive electrode and a negative electrode which are in the same end face, for example, the positive electrode terminal 30 and the negative electrode terminal 32 shown in FIG. 9. The battery connection module 20 include a tray 22 and a plurality of connecting busbars A. Hereinafter in combination with FIG. 8 to FIG. 10, a structure, a connecting manner and a function relationship of each main constituting part of the battery connection module 20 provided by the present disclosure will be described in detail.

As shown in FIG. 8 to FIG. 10, in an embodiment of the present disclosure, a plurality of connecting busbars A are assembled on the tray 22. Each connecting busbar A has a plurality of components (A1-A5), each component (A1-A5) has a main body portion 60, a head portion 62 which extends from a first end of the main body portion 60 and a foot portion 64 which extends from a second end of the main body portion 60. The head portion 62 is connected to the positive of a corresponding electrode battery cell 24, the foot portion 64 is connected to the negative electrode of a corresponding battery cell 24. The main body portions 60 of the components (A1-A5) of the connecting busbar A are connected via a corresponding connecting portion 58. On this basis, in each connecting busbar A, at least one component (A1-A5) connects two battery cells 24 of adjacent columns, at least one component (A1-A5) connect two battery cells 24 of every other column, at least one component (A1-A5) connects two battery cells 24 of the same row, and at least one component (A1-A5) connects two battery cells 24 of adjacent rows. Each battery cell 24 of the array of the battery cells 24 has the positive electrode and the negative electrode which are in the same end face, the battery cells 24 of adjacent columns are staggered in the corresponding rows so that the battery cells 24 forms a regular symmetric arrangement, in such an array of the battery cells 24, by the battery connection module 20 promoted by the present disclosure, it can use one connecting busbar A to realize connection with more number of the battery cells 24, can connect the battery cells 24 which are not positioned in regular symmetric positions, at the same time can use a plurality of connecting busbars A which each has a different irregular symmetric configuration to connect the battery cells 24.

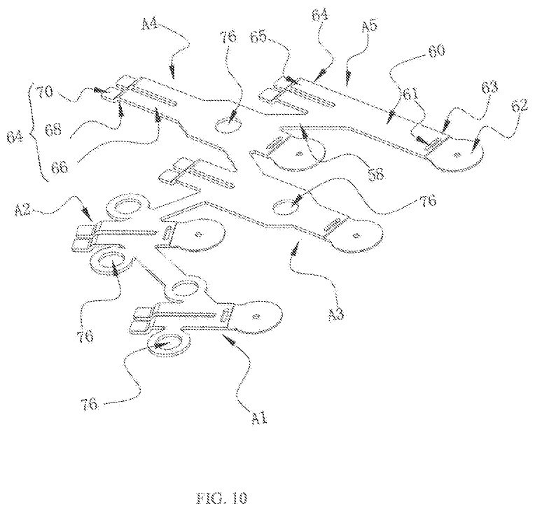

As shown in FIG. 10, in an embodiment of the present disclosure, the main body portion 60 is a plane structure and extends linearly. On this basis, a thickness of the head portion 62 is less than a thickness of the main body portion 60, a lower surface of the head portion 62 is coplanar with a lower surface of the main body portion 60.

As shown in FIG. 10, in an embodiment of the present disclosure, a middle of the foot portion 64 of each component (A1-A5) of the connecting busbar provided with a slit to form two branching feet 65, the two branching feet 65 also may be a splayed construction, or the foot portion 64 also may form three or more branching feet 65.

As shown in FIG. 8 and FIG. 10, in an embodiment of the present disclosure, the foot portion 64 has a first part 66, a second part 68 and a third part 70. Specifically, the first part 66 extends from the main body portion 60 and is coplanar with the main body portion 60, the second part 68 extends downwardly and obliquely from the first part 66 by an angle, the third part 70 extends from second part 68 by an angle and is parallel to the first part 66, the third part 70 is used to connect the negative electrode of the corresponding battery cell 24.

As shown in FIG. 10, in an embodiment of the present disclosure, the main body portion 60 of each component (A1-A5) of the connecting busbar A is provided with a fusible portion 63 which acts as overcurrent protection, a cross sectional area of the fusible portion 63 in a thickness direction is minimum relative to a cross sectional area of the other part of the main body portion 60, so that the fusible portion 63 has high resistance, can generate large heat and can be fused under overcurrent.

As shown in FIG. 10, based on the design that the main body portion 60 is provided with the fusible portion 63, in an embodiment of the present disclosure, the main body portion 60 is provided with a material removed portion 61 close to the head portion 62 and an elongated fusible portion 63 is constructed by the material removed portion 61. In some embodiments, the material removed portion 61 may be a groove, a through hole and the like, in addition, the material removed portion 61 also may be provided with at least two different types of thinning structures so as to construct the fusible portion 63 on the main body portion 60, for example, the through hole and the groove and the like are provided at the same time. In the present embodiment, the fusible portion 63 provided at a position of the main body portion 60 close to head portion 62 is taken as an example for description, in some embodiments, the fusible portion 63 also may be provided at a position of the main body portion 60 close to the foot portion 64, or is provided at other position of the main body portion 60, and the present disclosure is not limited thereto.

As shown in FIG. 9, in an embodiment of the present disclosure, the tray 22 has the triangular region 38 among three corresponding adjacent battery cells 24, the connecting busbar A is coupled to the triangular region 38 of the tray 22.

As shown in FIG. 9 and FIG. 10, based on the design that the tray 22 has the triangular region 38, in an embodiment of the present disclosure, the connecting busbar A is provided with a first assembling hole 76, the first assembling hole 76 is aligned with the triangular region 38 of the tray 22. On this basis, the connecting busbar A and the tray 22 are assembled by a connecting member which extends through the first assembling hole 76 and is connected with the triangular region of the tray 22.

As shown in FIG. 9, based on the design that the connecting busbar A is provided with the first assembling hole 76, in an embodiment of the present disclosure, the triangular region 38 of the tray 22 is provided with a second assembling hole 74, the second assembling hole 74 is aligned with the first assembling hole 76. On this basis, the connecting busbar A and the tray 22 are assembled by a connecting member which extends through the first assembling hole 76 and the second assembling hole 74.

In an embodiment of the present disclosure, the connecting member which extends through the first assembling hole 76 and the second assembling hole 74 may be a connecting pin. In some embodiments, the connecting member also may employ other structure, for example, a screw, a rivet and the like, and the present disclosure is not limited thereto.

In some embodiments, the tray 22 also may be not provided with the second assembling hole 74, and the connecting member employs a manner that the connecting member is integrally provided to the triangular region 38 of the tray 22, an end of the connecting member extends through the first assembling hole 76.

Based on the design that the connecting member is integrally provided to the tray 22 and an end of the connecting member extends through the first assembling hole 76, in some embodiments, a part of the end of the connecting member through the first assembling hole 76 is connected with the connecting busbar A by hot melting or riveting.

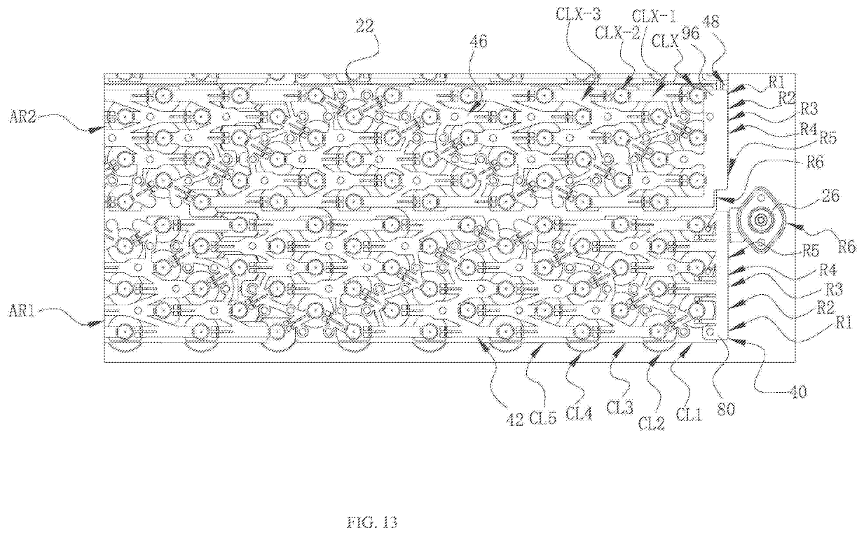

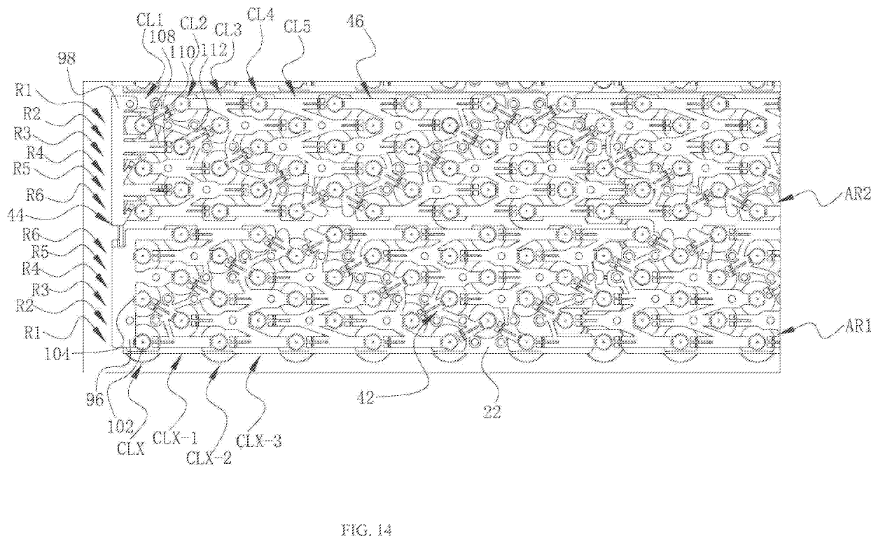

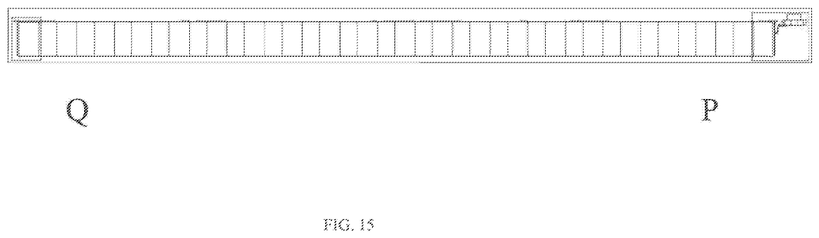

It is noted that, in a row direction of one battery cell array, it may be longer in length, so a plurality of trays 22 may be provided. For example, FIG. 3 only exemplarily illustrates one of the trays 22, FIG. 13 and FIG. 14 illustrate the trays 22 which respectively belong to two adjacent rows may be connected together (for example but is not limited to employ an integral structure).

As shown in FIG. 8 to FIG. 10, in an embodiment of the present disclosure, each column of the array of the battery cells 24 has Y battery cells 24 and is the same in the number of battery cells 24, each connecting busbar A includes X head portions 62 and X foot portions 64, and X is larger than Y. In the present embodiment, Y=3, X=5, that is, each column of the battery cell array of the present embodiment includes three battery cells and the battery cell array constitutes six rows of the battery cells, the plurality of connecting busbars are arranged to repeat a group that six connecting busbars (A-F) having different structure feature are continuously arranged so that a plurality of groups is formed to connect the battery cells, each connecting busbar has five components, five head portions and five foot portions. Each connecting busbar spans the battery cells of four columns and connects ten battery cells 24 of the battery cells (the five head portions respectively connect the positive electrodes of five battery cells and the five foot portions respectively connect the negative electrodes of additional five battery cells).

As shown in FIG. 8 to FIG. 10, in an embodiment of the present disclosure, a plurality of the connecting busbars A are divided to a plurality of groups which repeatedly arrange one of the plurality of groups, each group includes at least two connecting busbars A, the connecting busbars A of the same group are not completely the same in structure feature. Here, the above structure feature includes at least one of a position, an extending length, a width, a relative angle of the main body portion 60, the head portion 62, the foot portion 64 and the connecting portion 58 of any component (A1-A5) of the connecting busbar A.

It should be noted here that the battery connection module shown in the drawings and described in the present specification are only a few examples of the many types of battery connection modules which can employ the principles of the present disclosure. It should be clearly understood that the principles of the present disclosure are not limited to any detail or any element of the battery connection module illustrated in the drawings or described in the present specification.

Based on the above detailed description of several exemplary embodiments of the battery connection module provided by the present disclosure, hereinafter exemplary embodiments of the battery pack provided by the present disclosure will be described.

As shown in FIG. 10, in an embodiment of the present disclosure, each component A1-A5 of the connecting busbar A includes a main body portion 60 which is a plane structure and extends linearly, a head portion 62 which extends from a first end of the main body portion 60 and a foot portion 64 which extends from a second end of the main body portion 60. Here, a middle of the foot portion 64 of each component A1-A5 of the connecting busbar A may be provided with a slit to construct two branching feet 65, and the foot portion 64 may be flexible. With respect to each component (A1-A5 to Nx-Nx5), the head portion 62 is connected to the positive electrode terminal 30 of one of the battery cells 24, and the foot portion 64 is connected to the negative electrode terminal 32 of another of the battery cells 24. Therefore, if the connecting busbar A provides five components, ten battery cells 24 may be connected together via the connecting busbar A.

As shown in FIG. 10, in an embodiment of the present disclosure, each head portion 62 is a plane structure and has a lower surface, the lower surface is engaged with the positive electrode terminal 30 of the corresponding battery cell 24 which is connected with the lower surface. Each head portion 62 may be circular so as to be consistent in shape with the positive electrode terminal 30 of the battery cell 24 which is connected to the head portion 62. A thickness of the head portion 62 (measured between the lower surface and an opposite upper surface) is less than a thickness of main body portion 60 (measured between a lower surface of the main body portion 60 and an opposite upper surface of the main body portion 60). In some embodiments, the thickness of the head portion 62 is a half of the thickness of the main body portion 60. Such a reduced thickness of the head portion 62 may be formed by thinning operation (for example milling). The lower surface of the head portion 62 is coplanar with the lower surface of the main body portion 60.

As shown in FIG. 10, in an embodiment of the present disclosure, each foot portion 64 has a first part 66 which extends from the main body portion 60 and is positioned in the same plane as the main body portion 60, a second part 68 which extends from the first part 66 and has an angle with the first part 66, and a third part 70 which extends from the second part 68 and has an angle with the second part 68. The main body portion 60 and the third part 70 are parallel to each other. On this basis, the slit of foot portion 64 may penetrates the first part 66, the second part 68 and the third part 70, so elasticity of the foot portion 64 can be further increased. A lower surface of each third part 70 is engaged with the negative electrode terminal 32 of the corresponding battery cell 24 which is connected with the lower surface of the third part 70. A groove 61 and a fusible portion 63 positioned at two sides of the groove 61 are provided in the main body portion 60 and are close to the head portion 62. Relative to the main body portion 60, each fusible portion 63 has a smaller cross sectional area and so has a higher resistance, can generates large heat and is fused under overcurrent, the fusible portion 63 is used for overcurrent protection (fused protection). Each fusible portion 63 may have the same cross sectional area.

As shown in FIG. 10, in an embodiment of the present disclosure, the connecting portion 58 basically extends along a straight line between the main body portions 60 of the components (A1-A5 to Nx-Nx5), so this provides a direct electrical path, provides a smaller resistance and a lower power loss.

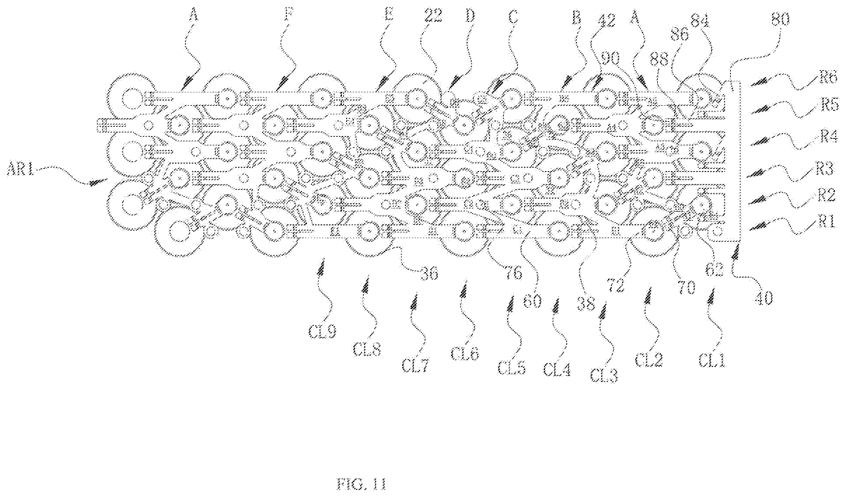

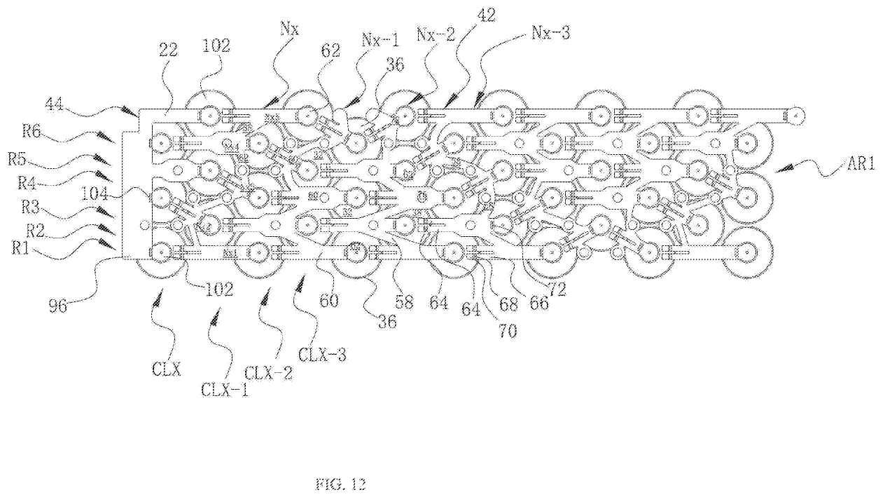

As shown in FIG. 11 and FIG. 12, the following paragraphs describe an embodiment of the first group 42 of the connecting busbars and the first array AR1 of the battery cell array the third group 50 and the third array AR3 also have the same construction).

As shown in FIG. 11 and FIG. 12, each column (CL1-CLX) of each battery cell array includes three battery cells 24 and is the same in the number of the battery cells 24, the battery cells 24 of adjacent columns are offset and staggered relative to each other and the corresponding battery cell 24 of one column is positioned between two corresponding battery cells 24 of the other column, these column repeat arrangement of the adjacent columns from the column CL1 to column CLX in the row direction so as to constitute six rows of the battery cells 24, so that the battery cells 24 of adjacent rows are offset and staggered relative to each other and the corresponding battery cell 24 of one row is positioned between two corresponding battery cells 24 of the other row. The first group 42 connecting the first array AR1 of the battery cell array includes a plurality of connecting busbars (A to Nx), the plurality of connecting busbars are arranged to repeat a group that six connecting busbars (A-F) having different structure feature are continuously arranged so that a plurality of groups is formed to connect the battery cells 42

As shown in FIG. 11, in an embodiment of the present disclosure, the first connecting busbar A has components A1, A2, A3, A4, A5. Referring to FIG. 11, the head portion 62 of the component A1 is connected to the battery cell 24 which is positioned in the first column CL1 and the second row R2, and the foot portion 64 of the component A1 is connected to the battery cell 24 which is positioned in the second column CL2 and the first row R1. The head portion 62 of the component A2 is connected to the battery cell 24 which is positioned in the second column CL2 and the third row R3, and the foot portion 64 of the component A2 is connected to the battery cell 24 which is positioned in the third column CL3 and the second row R2. The head portion 62 of the component A3 is connected to the battery cell 24 which is positioned in the first column CL1 and the fourth row R4, and the foot portion 64 of the component A3 is connected to the battery cell 24 which is positioned in the third column CL3 and the fourth row R4. The head portion 62 of the component A4 is connected to the battery cell 24 which is positioned in the second column CL2 and the fifth row R5, and the foot portion 64 of the component A4 is connected to the battery cell 24 which is positioned in the fourth column CL4 and the fifth row R5. The head portion 62 of the component A5 is connected to the battery cell 24 which is positioned in the first column CL1 and the sixth row R6, and the foot portion 64 of the component A5 is connected to the battery cell 24 which is positioned in the third column CL3 and the sixth row R6. The first connecting busbar A spans the battery cells 24 of the first column to the fourth column.

As shown in FIG. 11, in an embodiment of the present disclosure, the second connecting busbar B has components B1, B2, B3, B4, B5. The head portion 62 of the component B1 is connected to the battery cell 24 which is positioned in the second column CL2 and the first row R1, and the foot portion 64 of the component B1 is connected to the battery cell 24 which is positioned in the fourth column CL4 and the first row R1. The head portion 62 of the component B2 is connected to the battery cell 24 which is positioned in the third column CL3 and the second row R2, and the foot portion 64 of the component B2 is connected to the battery cell 24 which is positioned in the fifth column CL5 and the second row R2. The head portion 62 of the component B3 is connected to the battery cell 24 which is positioned in the third column CL3 and the fourth row R4, and the foot portion 64 of the component B3 is connected to the battery cell 24 which is positioned in the fourth column CL4 and the third row R3. The head portion 62 of the component B4 is connected to the battery cell 24 which is positioned in the fourth column CL4 and the fifth row R5, and the foot portion 64 of the component B4 is connected to the battery cell 24 which is positioned in the fifth column CL5 and the fourth row R4. The head portion 62 of the component B5 is connected to the battery cell 24 which is positioned in the third column CL3 and the sixth row R6, and the foot portion 64 of the component B5 is connected to the battery cell 24 which is positioned in the fifth column CL5 and the sixth row R6. The second connecting busbar B spans the battery cells 24 of the second column to the fifth column.

As shown in FIG. 11, in an embodiment of the present disclosure, the third connecting busbar C has components C1, C2, C3, C4, C5. The head portion 62 of the component C1 is connected to the battery cell 24 which is positioned in the fourth column CL4 and the first row R1, and the foot portion 64 of the component C1 is connected to the battery cell 24 which is positioned in the sixth column CL6 and the first row R1. The head portion 62 of the component C2 is connected to the battery cell 24 which is positioned in the fifth column CL5 and the second row R2, and the foot portion 64 of the component C2 is connected to the battery cell 24 which is positioned in the seventh column CL7 and the second row R2. The head portion 62 of the component C3 is connected to the battery cell 24 which is positioned in the fourth column CL4 and the third row R3, and the foot portion 64 of the component C3 is connected to the battery cell 24 which is positioned in the sixth column CL6 and the third row R3. The head portion 62 of the component C4 is connected to the battery cell 24 which is positioned in the fifth column CL5 and the fourth row R4, and the foot portion 64 of the component C4 is connected to the battery cell 24 which is positioned in the seventh column CL7 and the fourth row R4. The head portion 62 of the component C5 is connected to the battery cell 24 which is positioned in the fifth column CL5 and the sixth row R6, and the foot portion 64 of the component C5 is connected to the battery cell 24 which is positioned in the sixth column CL6 and the fifth row R5. The third connecting busbar C spans the battery cells 24 of the fourth column to the seventh column.

As shown in FIG. 11 and FIG. 12, in an embodiment of the present disclosure, the connecting busbars D, E, F, Nx, Nx-1, Nx-2, Nx-3 are labeled, but are not specifically and repeatedly described again. When reviewing the drawings, positions of the head portion 62 and the foot portion 64 of each component of the connecting busbars D, E, Nx, Nx-1, Nx-2, Nx-3 are apparent. Each connecting busbar above spans the battery cells 24 of corresponding four columns.

As shown in FIG. 12, in an embodiment of the present disclosure, the connecting busbars (A to Nx) along the array AR1, AR3 continuously extend, until the last one connecting busbar Nx is provided, as best shown in FIG. 12. As shown in the figure, the last connecting busbar Nx is coupled to battery cell 24 of the last four columns CLX, CLX-1, CLX-2, CLX-3.

As mentioned above, some component connects the battery cells 24 of adjacent columns, and some component connects the battery cell 24 of every other column. Some component connects the battery cells 24 of the same row, and some component connects the battery cells 24 of adjacent rows. The battery cells 24 connected by each component depend on the array.

A1 though the four groups 42, 46, 50, 54 of the connecting busbars and the associated bridging busbars 44, 48, 52 thereof are illustrated with respect to each block BL1, BL2, at least two groups 42, 46 and the associated bridging busbar 44 may be provided, and the last one connecting busbar is coupled to the outputting busbar 56. Or, only single group 42 may be coupled to the inputting busbar 40 and the outputting busbar 56.

As shown in FIG. 5, in an embodiment of the present disclosure, a plurality of positions of each connecting busbar (A to Nx) along a length direction of the tray 22 may be respectively connected to the triangular regions 38 of the tray 22. The connecting busbar (A to Nx) may be coupled to the triangular region 38 by a connecting pin (not shown), the connecting pin extends through the assembling hole 74 of the tray 22 and through the assembling hole 76 of the connecting busbar (A to Nx), the assembling hole 76 is aligned with the assembling hole 74 of the triangular region 38 of the tray 22. For example, the connecting pin may be a plastic post which is used to connect the connecting busbar (A to Nx) to the tray 22 by hot melting, or a plastic rivet which is used to fix the connecting busbar(A to Nx) to the tray 22, the assembling hole 76 of the connecting busbar (A to Nx) may be provided in the main body portion 60 or the connecting portion 58, it specifically may depend on which portion of the connecting busbar (A to Nx) is overlapped with the assembling hole 74 of the tray 22.

As shown in FIG. 13 and FIG. 14, in an embodiment of the present disclosure, the second group 46 and the fourth group 54 which cover the arrays AR2, AR4 respectively are in a state that the second group 46 and the fourth group 54 which cover the arrays AR2, AR4 respectively are substantial rotated by 180 degrees relative to the structures of the first group 42 and the third group 50 which cover the array AR1, AR3 respectively. That is, with respect to the first group 42 and the third group 50 which covers the array AR1, AR3 respectively, the first column CL1 and the first row R1 are positioned at the lower right of the array AR1, AR3 in the figures (shown in FIG. 6) and the last column CLX and the first row R1 are positioned at the lower left of the array AR1, AR3 (shown in FIG. 7), with respect to each of the second group 46 and the fourth group 54 which cover the arrays AR2, AR4 respectively, the first column CL1 and the first row R1 are positioned at the upper left corner of the array AR2, AR4, and the last column CLX and the first row R1 are positioned at the upper right corner of the array AR2, AR4.

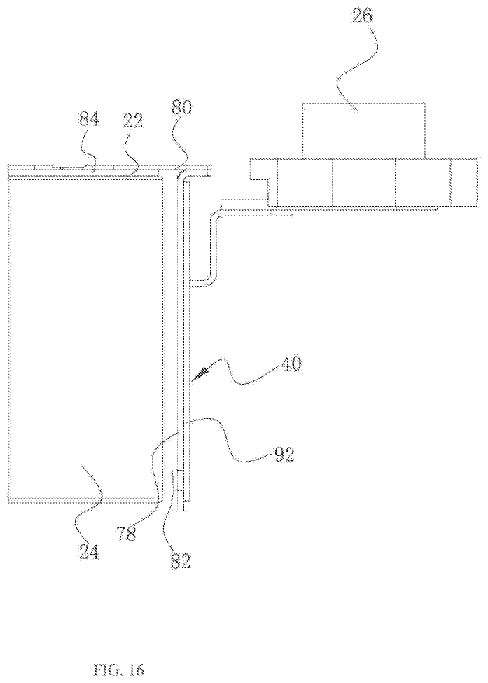

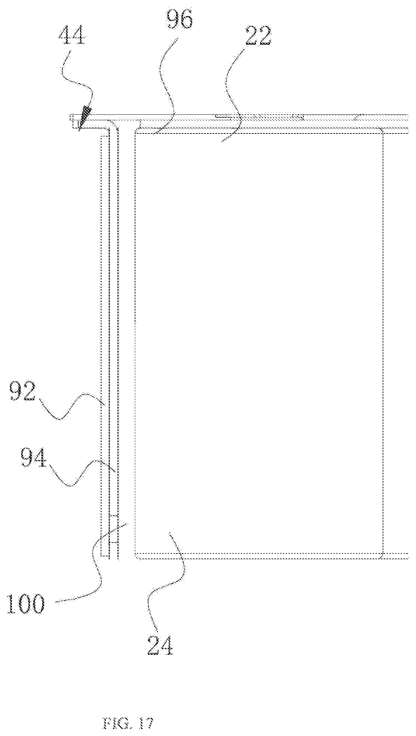

As shown in FIG. 16, in an embodiment of the present disclosure, the inputting busbar 40 of each block BL1, BL2 includes a first inputting busbar 78 and a second inputting busbar 80 which are electrically coupled together. The first inputting busbar 78 is a strip-shaped structure, has an inner surface and an outer surface which are parallel to each other, is perpendicular to the tray 22 and extends along the first column CL1 of the battery cells 24 of the array AR1, and extends along a height of the battery cells 24. The first inputting busbar 78 is arranged to be spaced apart from the battery cells 24 to form a gap 82. The first inputting busbar 78 forms a heat sink which is used to dissipate heat from the battery cells 24. As shown in FIG. 11, the second inputting busbar 80 is a strip-shaped structure, has an inner parallel surface and an outer parallel surface, extends parallel to the tray 22 and partially covers the tray 22. The first inputting busbar 78 and the second inputting busbar 80 are perpendicular to each other and may be welded together. The inputting interface 26 is electrically coupled to the first inputting busbar 78. A plurality of leg portions 84 extend from an edge of the second inputting busbar 80 and are engaged with the corresponding negative electrode terminals 32 of the battery cells 24 of the first column CL1 and the second column CL2. As shown in FIG. 11, each leg portion 84 has a first part 86 which extends from the second inputting busbar 80 and is positioned in the same plane as the second inputting busbar 80, a second part 88 which extends from the first part 86 and has an angle relative to the first part 86, and a third part 90 which extends from the second part 88 and has an angle relative to the second part 88. The second inputting busbar 80 and the third part 90 are parallel to each other. A lower surface of each third part 90 is engaged with the negative electrode terminal 32 of the corresponding battery cell 24 which is connected with the lower surface of the third part 90. The first inputting busbar 78 may be provided with a lid 92 thereon, the lid 92 may covers each busbar and the bridging busbar which are positioned at the same side as the lid 92, as better shown in FIG. 1.

As shown in FIG. 6 to FIG. 17, in an embodiment of the present disclosure, the first bridging busbar 44 includes a first bridging bus-bar 94, a second bridging bus-bar 96 and a third bridging bus-bar 98 which are electrically coupled together. The first bridging bus-bar 94 is a strip-shaped structure, has an inner surface and an outer surface which are parallel to each other, is perpendicular to the tray 22 and extends along the last column CLX of the battery cells 24 of the array AR1 and along the first column CL1 of the battery cells 24 of the array AR2. The first bridging bus-bar 94 extends along a height of the battery cells 24 of the arrays AR1, AR2. The first bridging bus-bar 94 is spaced apart from the battery cells 24 of each of the arrays AR1, AR2, so that a gap 100 is formed. The first bridging bus-bar 94 forms a heat sink which is used to dissipate heat from the battery cells 24 of the arrays AR1, AR2. The second bridging bus-bar 96 is a strip-shaped structure, and has an inner surface and an outer surface which are parallel to each other, extends parallel to the tray 22 and is partially covers the tray 22. The first bridging bus-bar 94 and the second bridging bus-bar 96 are perpendicular to each other and may be welded together. A plurality of head portions 102 extend from an edge of the second bridging bus-bar 96 and are engage with the positive electrode terminals 30 of the battery cells 24 of the columns CLX, CLX-1 of the array AR1. Each head portion 102 is a planes structure and has a lower surface, the lower surface is engaged with the positive electrode terminal 30 of the corresponding battery cell 24 which is connected with the lower surface. Each head portion 102 may be circular so as to be consistent in shape with the positive electrode terminal 30 of the battery cell 24 which is connected to the head portion 102. A thickness of the head portion 102 (measured between the lower surface and an opposite upper surface) is less than a thickness of the second bridging bus-bar 96 (measured between a lower surface of the second bridging bus-bar 96 and an opposite upper surface of the second bridging bus-bar 96). In some embodiments, the thickness of the head portion 102 is a half of the thickness of the second bridging bus-bar 96. Such a reduced thickness of the head portion 102 may be formed by thinning operation, for example, milling. The lower surface of the head portion 102 is coplanar with the lower surface of the second bridging bus-bar 96. A groove 104 and a fusible portion positioned at two sides of the groove 104 are provided in the second bridging bus-bar 96 close to each head portion 102, the fusible portion acts as overcurrent protection. Each groove 104 has a cross sectional area which is the same as the cross sectional area of the groove 72 and is positioned close to the head portion 102, so as to provide a consistent protection under overcurrent.

As shown in FIG. 6 to FIG. 17, in an embodiment of the present disclosure, the first bridging bus-bar 94 and the third bridging bus-bar 98 are perpendicular to each other and may be welded together. A plurality of pairs of foot portions 106 extend from an edge of the third bridging bus-bar 98 and are engaged with the negative electrode terminals 32 of the battery cells 24 of the columns CL1, C2 of the second array AR2. Each foot portion 106 has a first part 108 which extends from the third bridging bus-bar 98 and is positioned in the same plane as the third bridging bus-bar 98, a second part 110 which extends from the first part 108 and has an angle relative to the first part 108, and a third part 112 which extends from the second part 110 and has an angle relative to the second part 110. The third bridging bus-bar 98 and the third part 112 are parallel to each other. A lower surface of each third part 112 is engaged with the negative electrode terminal 32 of the corresponding battery cell 24 which is connected with the lower surface of each third part 112.

As shown in FIG. 6 to FIG. 17, in an embodiment of the present disclosure, a forming manner of the second bridging busbar 48 is similar to that of the first bridging busbar 44, so detailed description is not repeated herein. The head portions 102 of the second bridging bus-bar 96 of the second bridging busbar 48 are coupled to the positive electrode terminals 30 of the battery cells 24 of the columns CLX, CLX-1 of the array AR2, and the foot portions 106 of the third bridging bus-bar 98 of the second bridging busbar 48 are coupled to the negative electrode terminals 32 of the battery cells 24 of the columns CL1, CL2 of the array AR3.

As shown in FIG. 6 to FIG. 17, in an embodiment of the present disclosure, the third bridging busbar 52 is form similarly to the first and second bridging busbars 44, 48, and detailed description is not repeated again. The head portions 102 of the second bridging bus-bar 96 of the third bridging busbar 52 are coupled to the positive electrode terminals 30 of the battery cells 24 of the columns CL1, CL2 of the array AR3, and the foot portions 106 of the third bridging bus-bar 98 of the third bridging busbar 52 are coupled to the negative electrode terminals 32 of the battery cell 24 of the columns CL1, CL2 of the array AR4.

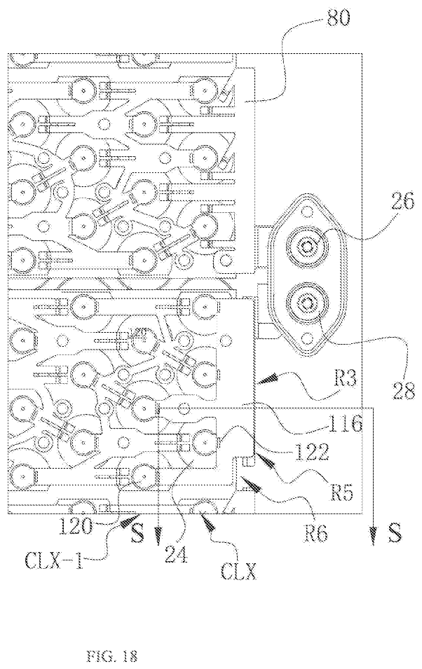

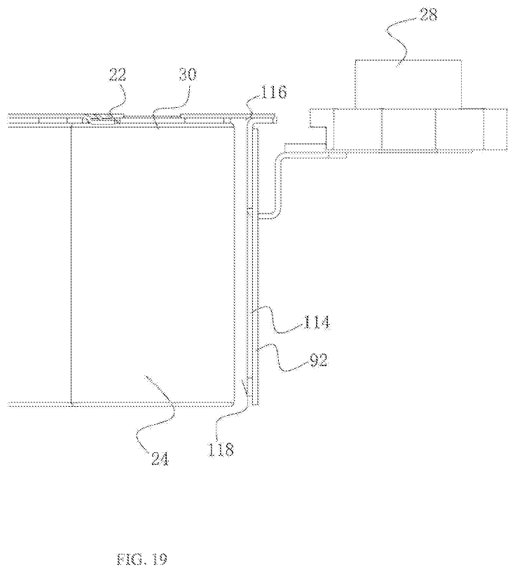

As shown in FIG. 18 and FIG. 19, in an embodiment of the present disclosure, the outputting busbar 56 includes a first outputting busbar 114 and a second outputting busbar 116 which are electrically coupled together. The first outputting busbar 114 is a strip-shaped structure, has an inner surface and an outer surface which are parallel to each other, is perpendicular to the tray 22 and extends along the last column CLX of the battery cells 24 of the array AR4, and extends along a height of the battery cells 24. The first outputting busbar 114 is spaced apart from the battery cells 24, so that a gap 118 is formed. The first outputting busbar 114 forms a heat sink which is used to dissipate heat from the battery cells 24. The second outputting busbar 116 is a strip-shaped structure, has an inner surface and an outer surface which are parallel to each other, extends parallel to the tray 22 and partially covers the tray 22. The first outputting busbar 114 and the second outputting busbar 116 are perpendicular to each other and may be welded together. The outputting interface 28 is electrically coupled to the first outputting busbar 114. A plurality of head portions 120 extend from an edge of the second outputting busbar 116 and are engage with the positive electrode terminals 30 of the battery cells 24 of the columns CLX, CLX-1. Each head portion 120 is a plane structure and has a lower surface, the lower surface is engaged with the positive electrode terminal 30 of the corresponding battery cell 24 which is connected with the lower surface. Each head portion 120 may be circular so as to be consistent in shape with the positive electrode terminal 30 of the battery cell 24 which is connected with the head portion 120. The head portion 120 has a thickness (measured between the lower surface and an opposite upper surface) which is smaller than a thickness of the second outputting busbar 116 (measured between a lower surface of the second outputting busbar 116 and an opposite upper surface of the second outputting busbar 116). In some embodiments, the thickness of the head portion 120 is a half of the thickness of the second outputting busbar 116. Such a reduced thickness of the head portion 120 may be formed by thinning operation, for example, milling. The lower surface of the head portion 120 is coplanar with the lower surface of the second outputting busbar 116. A groove 122 and a fusible portion positioned at two sides of the groove 122 are provided in the second outputting busbar 116 close to the head portion 120. The fusible portion acts as overcurrent protection. Each groove 122 has the same cross sectional area as the grooves 61, 104 and is positioned close to head portion 120 so as to provide a consistent protection under overcurrent.

As shown in FIG. 18 and FIG. 19, in an embodiment of the present disclosure, a power flows from the inputting interface 26, through the inputting busbar 40, through the group 42 and the array AR1, through the first bridging busbar 44, through the group 46, through the second bridging busbar 48, through the group 50, through the third bridging busbar 52, through the group 54 and reaches the outputting busbar 56 and the outputting interface 28.

In an embodiment of the present disclosure, the head portion 62, 102, 120 and the foot portion 64, 84, 106 are connected to the corresponding battery cells 24, for example, by welding.

It should be noted here that the battery pack shown in the drawings and described in the present specification are only a few examples of the many types of battery packs which can employ the principles of the present disclosure. It should be clearly understood that the principles of the present disclosure are not limited to any detail or any element of the battery pack illustrated in the drawings or described in the present specification.

In conclusion, each battery cell of the array of the battery cells has the positive electrode and the negative electrode which are in the same end face, the battery cells of adjacent columns are staggered in the corresponding rows so that the battery cells forms a regular symmetric arrangement, in such an array of the battery cells, by the battery connection module promoted by the present disclosure, it can use one connecting busbar to realize connection with more number of the battery cells, can connect the battery cells which are not positioned in regular symmetric positions, at the same time can use a plurality of connecting busbars which each has a different irregular symmetric configuration to connect the battery cells.

Exemplary embodiments of the battery connection module and the battery pack provided by the present disclosure are described in detail and/or illustrated as above. However, the embodiments of the present disclosure are not limited to the specific embodiments described herein, but rather, constituting parts and/or steps of each embodiment may be used independently and separately from other constituting parts and/or steps described herein. Each constituting part and/or each step of one embodiment may also be used in combination with other constituting part and/or step of other embodiments. When introducing elements/introducing /etc. described and/or illustrated herein, the terms “a”, “an”, “the” and the like are used to indicate that there are one or more elements/constituting part/etc. The terms “comprise”, “include” and “has/have” are used to indicate an open-ended inclusive meaning and mean that there may be additional element/constituting part/etc. in addition to the listed element/constituting part/etc. In addition, the terms “first” and “second” and the like in the claims and the specification are used only as labels, and are not to limit the digit which they are directed.

While the battery connection module and battery pack provided by the present disclosure have been described according to various specific embodiments, those skilled in the art will appreciate that modifications may be made to practice the present disclosure within the spirit and scope of the claims.

1. A battery connection module which is used to connect a battery cell array, the battery cell array comprising a plurality of columns and each column comprising battery cells and being the same in the number of battery cells, a battery cell of one column of adjacent columns being positioned between two corresponding battery cells of the other column of the adjacent columns, the plurality of columns repeating arrangement of the adjacent columns in a row direction and constituting a plurality of rows of the battery cells, a battery cell of one row of adjacent rows being positioned between two corresponding battery cells of other row of the adjacent rows, each battery cell having a positive electrode and a negative electrode which are positioned on the same end face, the battery connection module comprising:
a tray; and
a plurality of connecting busbars which are assembled on the tray;
each connecting busbar having a plurality of components, each component having a main body portion, a head portion which extends from a first end of the main body portion and a foot portion which extends from a second end of the main body portion, the head portion being connected to the positive electrode of a corresponding battery cell, the foot portion being connected to the negative electrode of a corresponding battery cell, the main body portions of the components of the connecting busbar being connected by a connecting portion;
in each connecting busbar, at least one component connecting two battery cells of adjacent columns, at least one component connecting two battery cells of every other column, at least one component connecting two battery cells in the same row, and at least one component connecting two battery cells of adjacent rows.

2. The battery connection module according to claim 1,
wherein the main body portion is a plane structure and extends linearly;
wherein a thickness of the head portion is less than a thickness of the main body portion, a lower surface of the head portion is coplanar with a lower surface of the main body portion.

3. The battery connection module according to claim 1, wherein
the foot portion of each component of the connecting busbar has two branching feet.

4. The battery connection module according to claim 1, wherein
the foot portion has a first part, a second part and a third part,
the first part extends from the main body portion and is coplanar with the main body portion,
the second part extends downwardly and obliquely from the first part by an angle,
the third part extends from the second part by an angle and is parallel to the first part, the third part is used to connect the negative electrode of a corresponding battery cell.

5. The battery connection module according to claim 1, wherein
the main body portion of each component of the connecting busbar is provided with a fusible portion which acts as overcurrent protection, a cross sectional area of the fusible portion in a thickness direction is minimum relative to a cross sectional area of other part of the main body portion.

6. The battery connection module according to claim 5, wherein
the main body portion is provided with a material removed portion and the fusible portion is constructed by the material removed portion.

7. The battery connection module according to claim 1, wherein
the connecting busbar is provided with a first assembling hole, the connecting busbar and the tray are assembled by a connecting member which extends through the first assembling hole and is connected with the tray.

8. The battery connection module according to claim 7, wherein
the tray has a triangular region which is positioned among three corresponding adjacent battery cells, the first assembling hole of the connecting busbar is aligned with the triangular region of the tray.

9. The battery connection module according to claim 8,
wherein the triangular region of the tray is provided with a second assembling hole, the second assembling hole is aligned with the first assembling hole;
wherein the connecting busbar and the tray are assembled by the connecting member which extends through the first assembling hole and the second assembling hole.

10. The battery connection module according to claim 9, wherein
the connecting member is a connecting pin, a screw or a rivet.

11. The battery connection module according to claim 8,
wherein the connecting member is integrally provided to the triangular region of the tray;
wherein an end of the connecting member extends through the first assembling hole.

12. The battery connection module according to claim 11, wherein
a part of the end of the connecting member through the first assembling hole is connected with the connecting busbar by hot melting or riveting.

13. The battery connection module according to claim 1, wherein
each column of the battery cell array has Y battery cells and is the same in the number of battery cells,
each connecting busbar comprising X head portions and X foot portions, X larger than Y.

14. The battery connection module according to claim 13, wherein
the plurality of connecting busbars are divided to a plurality of groups which repeatedly arrange one of the plurality of groups,
each group comprising at least two connecting busbars, the connecting busbars of the same group are not completely the same in structure feature.

15. The battery connection module according to claim 14, wherein
each column of the battery cell array comprises three battery cell, and the plurality of columns constitute six rows of the battery cells,
the plurality of connecting busbars are arranged to repeat a group that six connecting busbars having different structure feature are continuously arranged so that a plurality of groups is formed to connect the battery cells, each busbar has five components, five head portions and five foot portions.

16. The battery connection module according to claim 15, wherein
each connecting busbar spans the battery cells of four columns.

17. A battery pack comprising a battery cell array and the battery connection module of claim 1.
